(19) United States
(12) Patent Application Publication
(10) Pub. No.: US 2007/0051173 A1
(43) Pub. Date: Mar. 8, 2007

(54) System for fault-tolerant fluid level sensing and switching

(76) Inventor: Laila Baniahmad, Palo Alto, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/876,859

(22) Filed: Jun. 24, 2004

(51) Int. Cl. G01F 23/00

(52) U.S. Cl. 73/291

(57) ABSTRACT

A fault-tolerant system and a method for controlling levels of a fluid in a vessel during a fluid operation, which may include draining the fluid from the vessel or filling the fluid into the vessel, are provided. A first signal indicating the first fluid level in the vessel is sensed by a primary sensor set of the system. A second signal indicating the second fluid level in the vessel is sensed by a secondary sensor set of the system. The fluid operation can be controlled using both the first signal from the primary sensor set and the second signal from the secondary sensor. Alternatively, the fluid operation can be controlled using the second signal from the secondary sensor set if the primary sensor set fails.

### FIELD

The present invention generally relates to semiconductor integrated circuit technology and, more particularly, to a method and apparatus for supplying process solutions.

### BACKGROUND

Conventional semiconductor devices generally include a semiconductor substrate, usually a silicon substrate, and a plurality of sequentially formed dielectric layers such as silicon dioxide and conductive paths or interconnects made of conductive materials. Interconnects are usually formed by filling a conductive material in trenches etched into the dielectric layers. In an integrated circuit, multiple levels of interconnect networks laterally extend with respect to the substrate surface. Interconnects formed in different layers can be electrically connected using vias or contacts.

The filling of a conductive material into features such as vias, trenches, pads or contacts, can be carried out by electrodeposition. In electrodeposition or electroplating method, a conductive material, such as copper is deposited over the substrate surface including into such features. Then, a material removal technique is employed to planarize and remove the excess metal from the top surface, leaving conductors only in the features or cavities. The standard material removal techniques that are commonly used for this purpose is chemical mechanical polishing (CMP), chemical etching and electropolishing, which is also referred to as electroetching or electrochemical etching.

In semiconductor processing, equipment reliability is of great importance due to the significant impact it has on total fabrication cost. A great deal of effort is routinely placed on increasing the reliability of the tools employed in semiconductor fabrication. Some steps in semiconductor fabrication require handling of processing or cleaning fluids.

In wet processes, the electrolytes, etching solutions and various other fluids are used as process fluids. During a process cycle, process fluids are periodically supplied to process modules from fluid tanks. The amount of fluid stored or filled in a fluid tank with a known volume can be determined by sensing the level of the fluid within the tank. Fluid level sensors can be employed to fill a fluid tank up to a predetermined level and to activate a pump to drain the tank once the fluid is reached at the predetermined level.

The fluid level sensors can be optical, capacitive, conductive, mechanical (floating) or ultrasonic. An exemplary system 10 including a fluid tank 12 with sensors 14 and 15 is illustrated in FIG. 1. In system 10, fluid 16 is supplied from a main tank or a storage tank 18 through a pipe 20. Pump 22 can be employed to deliver the fluid 16 to the fluid tank 12. When the fluid 16 reaches the desired level that is detected by the sensor 14, flow of the fluid 16 into the fluid tank 12 is stopped and the tank can be drained by a drain pump (not shown). The drained solution can be delivered to a process module. As the fluid level in the tank is lowered down to a minimum level detected by sensor 15, the pump 22 is activated again to fill the tank.

In operation, conventional fluid level sensors occasionally cause false detection due to a variety of factors. For example, fluid droplets left on or in the vicinity of the sensors cause false readings. Sticking problems in the case of float sensors, or calibration issues of optical and capacitive sensors can also cause false readings with such sensors. Therefore, there is a need for improved reliability of fluid level sensing in such applications. As shown in FIG. 2A in enlarged view, in most cases, the sensor signal is generated as soon as the fluid reaches near the surface of the sensor 14 or the surface of the sensor is exposed to the rising fluid. Once the predetermined fill level is detected by the sensor 14, the fluid flow is stopped and the draining of the tank can be started.

However, as shown in FIG. 2B, in such fluid level sensing processes, the fluid droplets 24 or residues can be left on the sensor or in the vicinity of the sensor as the fluid 16 is drained from the tank. These droplets 24 or residues also cause false detection in the subsequent filling of the fluid tank. This failure often brings highly undesirable outcome in applications requiring extreme reliability in fluid level sensing and supplying fluids

### SUMMARY

The present invention provides a fault-tolerant system and a method for controlling levels of a fluid in a vessel during a fluid operation such as draining the fluid from the vessel or filling the fluid into the vessel.

An aspect of the present invention provides a method of controlling levels of a fluid in a vessel during a fluid operation. The fluid operation includes draining the fluid from the vessel or filling the fluid into the vessel. During the process, a first signal indicating at least one first fluid level in the vessel is sensed by a primary sensor set. A second signal indicating at least one second fluid level in the vessel is sensed by a secondary sensor set. The fluid operation is controlled using both the first signal from the primary sensor set and the second signal from the secondary sensor set. Further, the fluid operation is controlled using the second signal from the secondary sensor set if the primary sensor set fails.

### BRIEF DESCRIPTION OF THE DRAWINGS

FIG. 1 is a schematic illustration of a prior art fluid level control system;

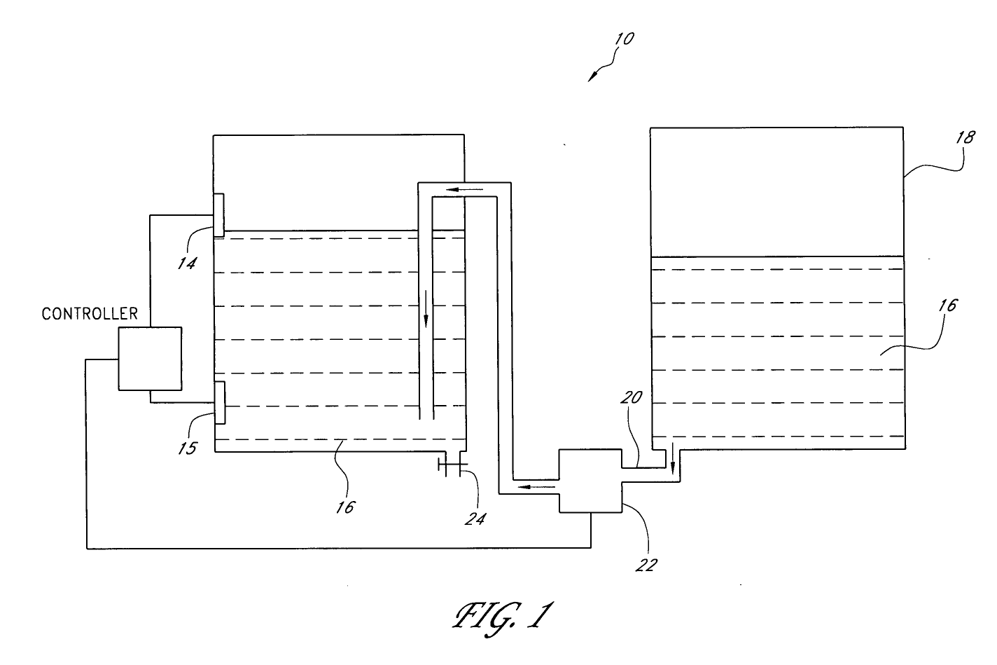

FIGS. 2A-2B are schematic illustrations of prior art sensors during operation;

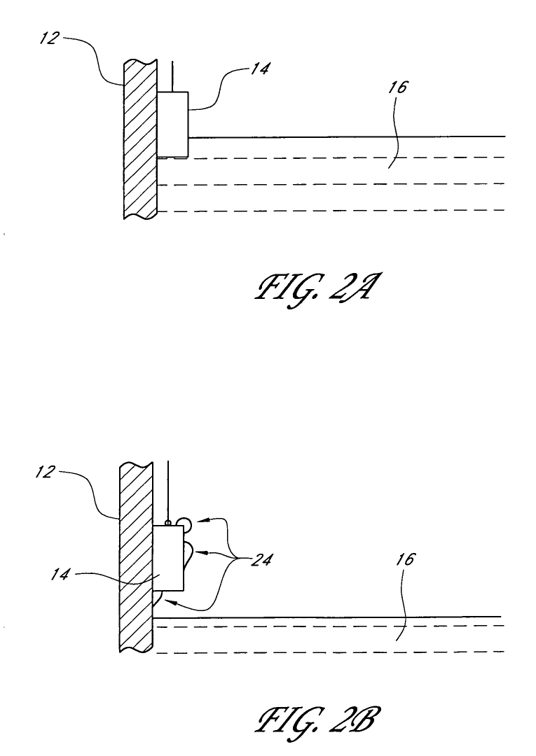

FIG. 3 is a schematic illustration of an embodiment of a fluid level sensing system of the present invention;

FIG. 4 is a schematic view of an embodiment of a control system of the fluid level sensing system of the present invention shown in FIG. 3;

FIG. 5 is another embodiment of the fluid level sensing system of the present invention;

FIG. 6 is an algorithm of operation schemes for the embodiment shown in FIG. 5; and

FIG. 7 is an embodiment of a sensor of the present invention.

### DETAILED DESCRIPTION

The present invention provides a fluid sensing method and system to determine fluid levels in fluid vessels such as storage tanks that are used to store process solutions used in the industry. However, although the system and method of the present invention may be used in the field of semiconductor processing, they may be used in any field using or storing solutions. The system of the present invention employs multiple sensors and switches to reliably fill and empty solution vessels. The system of the present invention achieves this by utilizing a series of redundant sensors of the same or different kinds with an appropriate control system.

In another embodiment of the present invention, the reliability of fluid level sensing process is enhanced in a fluid vessel by protecting the surface of a sensor or surface of such vessel in the immediate vicinity of the sensor from fluid residues by means of a gas pocket contained in a sensor housing. The gas pocket prevents fluid from leaving residues on the sensor so that the sensing action of the sensor is not perturbed by the fluid residues.

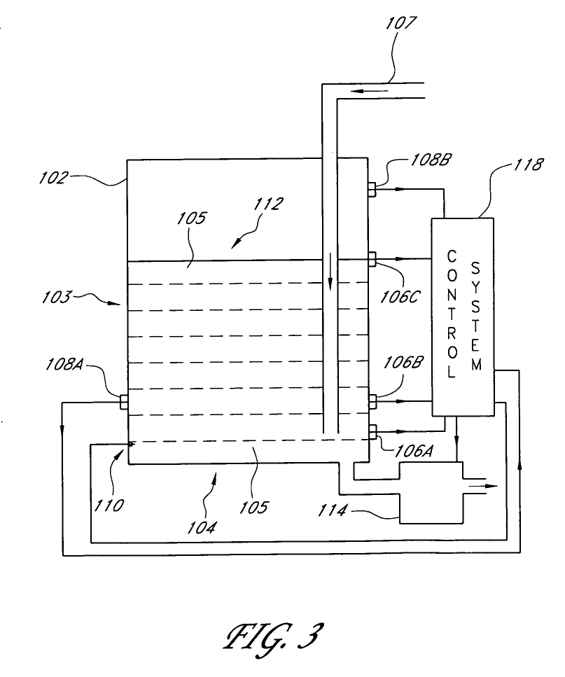

FIG. 3 illustrates an exemplary system 100 including a fluid vessel 102 having sidewalls 103 and a bottom wall 104. The vessel 102 contains a fluid 105 which may be a process solution such as an electroplating solution or an electropolishing solution, or any other solution. The process solution may be delivered to the vessel 102 using a solution line 107. A plurality of sensing devices, for example, a first sensor 106A, a second sensor 106B, a third sensor 106C, a fourth sensor 108A and a fifth sensor 108B of the present invention are employed to sense various predetermined levels of the solution to activate appropriate fluid operations such as draining or filling processes. The sensors 106A-106C and 108A-108B may preferably be attached to the sidewall 103 of the vessel 102 to sense the predetermined levels of the solution 105 in accordance with the principles of the present invention. The sensors and a drain pump 114 are connected to a control system 118. The control system 118 activates or deactivates the draining pump 114 based on the input from the sensors.

In this embodiment, the sensors 106A-106C and 108A-108B are functionally associated with one other in a redundant fashion. For example, a first group of sensors or primary sensors may be configured to include the first sensor 106A, the second sensor 106B and the third sensor 106C. The primary sensors in this embodiment are basically responsible for filling or emptying the solution vessel under normal operation conditions. For example, once the solution is allowed to reach the level of the third sensor 106C and detected by the third sensor, the draining process is started by the control system. The control system 118 activates the draining pump 114 and drains the solution. The level that is detected by the third sensor 106C to start draining will be referred to as first predetermined high solution level. During the draining, once the solution reaches the level of second sensor 106B and this is detected by the second sensor, the draining pump is stopped by the control system 118. The second sensor 106B detects a predetermined low solution level in the vessel during a draining. As will be explained below, it is almost a standard procedure to leave some solution in the vessel so as not to dry-run the draining pump, which may cause unwanted effects including but not limited to air bubbles in the solution or damaging the pump or reducing its life. The first sensor 106A is positioned below the second sensor 106B and is connected to the second sensor 106B for redundancy purposes. In this embodiment, if the second sensor 106B happens to fail, the draining of the solution continues down to another predetermined low solution level which is detected by the first sensor 106A and the draining is stopped.

Referring to FIG. 3, a second group of sensors or secondary sensors may be configured to include the fourth sensor 108A and the fifth sensor 108B. As will be described more fully below, the secondary sensors 108A, 108B establish a back-up system for the primary sensors 106A-106C. If the primary sensors fail, the secondary sensors drive the filling and draining process through the control system 118. The fourth sensor 108A may detect a third predetermined low solution level when the secondary sensors are needed as backup. The third predetermined low solution level may be equal to or lower than the second predetermined low solution level that is determined by the second sensor 106B of the primary sensors. The fifth sensor 108B may detect a second predetermined high solution level to start the draining of the vessel if the primary sensors fail.

As shown in FIG. 3, a signal source 110 is also included in the fluid vessel and located adjacent the bottom wall of the vessel. The signal source 110 emits a signal that is received by the sensors when the fluid level is at the level of a particular sensor, thereby detecting the level of the fluid. In this embodiment, the fluid is an electrically conductive fluid such as an electrolyte or an etching solution. In this respect, sensors of choice are conductive sensors. In one embodiment, the sensor material is preferably titanium-coated platinum. With the conductive sensors, the signal source 110 is a conductive probe that is connected to the electrical ground and exposed to the conductive solution. In this respect, when the solution touches the sensors, a conductive path is established between the sensors and the ground. Conductive path between the ground and a sensor provides a solution level input to the control system. Similarly, termination of this conductive path also show that the solution is no longer at that level.

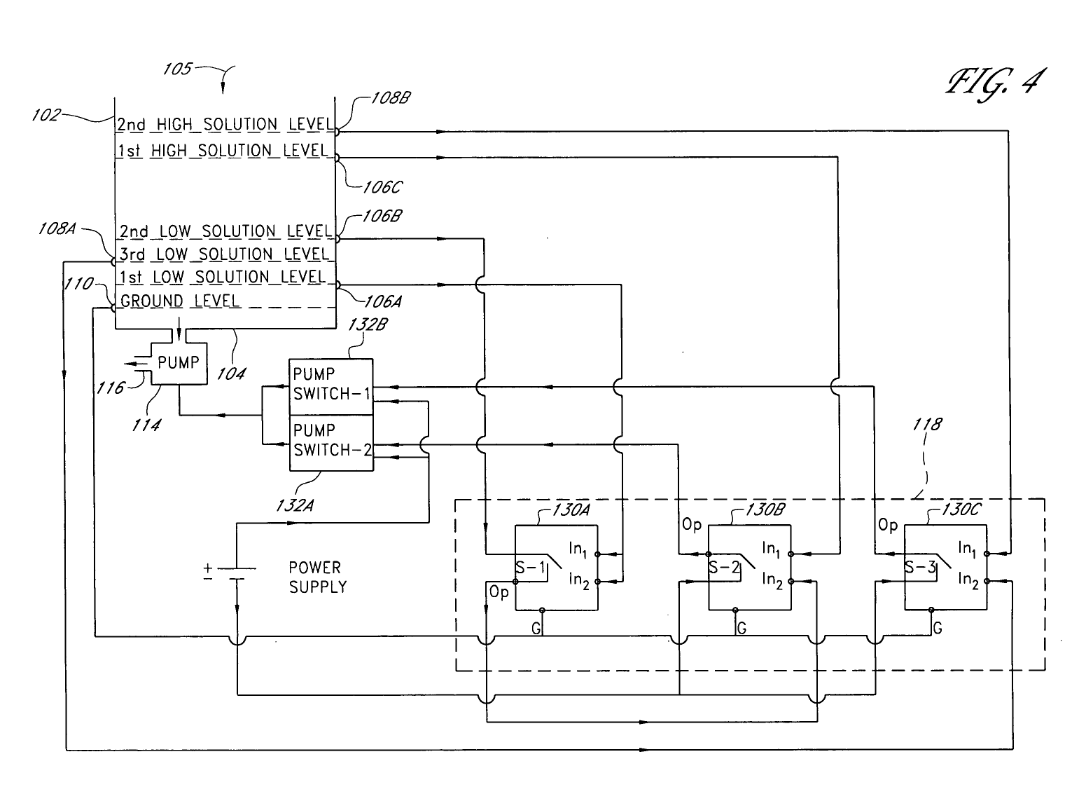

An exemplary operation process to fill and drain the fluid vessel 102 with a conductive fluid or process solution using the control system 118 and above described conductive sensor configurations will be described with reference to FIG. 4. In FIG. 4, each above-mentioned predetermined low or high solution levels and the ground level are shown using dotted lines extending from the corresponding sensors and the signal probe. As exemplified in FIG. 4, the control system 118 may comprise a first controller 130A, a second controller 130B and a third controller 130C. In this embodiment, the first and second controller 130A and 130B are associated with the primary sensors 106A-106C while the third controller 130C is associated with the second sensors 108A and 108B. Controllers 130A-130C receive input signals from the sensors and the signal source. In this embodiment, the input signals are in the form of electrical currents. As will be described more fully below, upon receiving the input signals, the controllers control a first pump switch 132A which is a solenoid valve in this embodiment for a pneumatically actuated pump and a second pump switch 132B or solenoid valve. The first switch 132A controls the pump, i.e., turns on or off the pump to start or stop draining, through the input from the primary sensors while the second switch controls the pump 114 through the input from the secondary sensors.

As described above, the sensors are conductive sensors and in this embodiment the electrical source is low voltage AC. The ground probe is connected to each controller 130A, 130B and 130C. As mentioned before there is always some solution left in the vessel under normal conditions to protect the pump 114 and not to let gas bubbles form in the solution 105 after the draining process. This level is determined by one of the low solution levels in which the sensors 106A, 106B or 108A is already shorted with the ground through the solution 105 and provides input for the control system 118. This level is preferably the second predetermined low level by the second sensor 106B. However, in order to describe how the control system controllers function, the process will be described as if the vessel is empty at the beginning of the process.

In FIG. 4, the controllers in the control system are presented in a simplified schematic. For this representation each controller has two inputs, which are In₁, and In₂, and one output Oₚ. The output Oₚ of each controller is provided by an output switch or contact switch S-1, S-2 and S-3 that are closed when both of its inputs In₁, and In₂ are turned on. However, once closed the output switch S-1, S-2 or S-3 will open only after both inputs In₁, and In₂ are turned off again. Furthermore for this representation, each sensor, whether primary or secondary, is on or active when current flows through it. Accordingly, as the solution 105 starts filling the vessel 102 from the bottom wall 104, the solution 105 first comes into contact with the ground probe 110 and then the solution is connected to the ground of the first, second and third controllers 130A, 130B and 130C. The first sensor 106A is connected to both inputs In₁, In₂ of the controller 130A. As such, when the solution 105 reaches the first predetermined low solution level of the first sensor 106A, current flows between the first sensor 106A and the ground through the solution 105 and as a result both inputs In₁, In₂ of the first controller 130A are turned on and therefore the output switch S-1 on the first controller 130A is closed.

Closing of the output switch S-1 of the first controller 130A connects the second sensor 106B to the input In₂ of the second controller 130B. When the solution 105 reaches the second sensor 106B and provides the second sensor 106B with a current path to the ground, current flows through the now closed output switch S-1 and leaves the first controller 130A as the output Oₚ. The output Oₚ of the first controller 130A turns on the input In₂ of the second controller 130B. At this instant, the output switch S-2 of the second controller 130B is still open. At the first predetermined high solution level, electrical connection between the third sensor 106C and the ground is established, and as a result the input In₁, of the second controller 130B is also turned on. Since both inputs In₁, and In₂ of the controller 130B are on, the output switch S-2 of the controller 130B closes and transmits the output Oₚ to the first pump switch 132A. The output Oₚ of the controller 130B in this embodiment directly actuates the first pump switch 132A of the pump 114. Thereafter, the pump begins draining solution from the vessel 102.

The draining process first turns off the In₁ of the second controller 130B by interrupting the connection between the ground and the third sensor 106C. Once the level of the solution goes just below the second predetermined low solution level, current flow from the second sensor 106B to the input In₂ of the second controller 130B is also interrupted. Since both inputs of the second controller are off, the output switch S-2 turns off as well, which results in turning off the first pump switch 132A and the pump 114.

One of the fault-tolerant aspects of the present invention may be described with the following example. In the above process, for example, if a malfunction happens and the input In₂ of the second controller 130B stays on after the fluid level is dropped below the second low solution level 106B, the pump 114 continues draining because the output switch S-2 of the second controller 130B is still on. However, as soon as the solution goes below the first predetermined low solution level of the first sensor 106A, both inputs In₁, and In₂ of the first controller 130A are turned off. This results in opening the switch S-1 of the first controller 130A and turning off the input In₂ of the second controller 130B. Since the inputs In₁, and In₂ of the second controller 130B are off, the output switch S-2 opens and turns off the first pump switch 132A to stop draining.

As described above, the secondary sensors (108A and 108B) provide a back-up system for the primary sensors (106A-106C) if the primary sensors fail. Referring to FIG. 4, in one embodiment, the secondary sensors function in the following redundant manner. The sensors 108A and 108B are activated in the same manner that the primary sensors are activated, i.e., by establishing a current flow between the sensor and the ground through the solution. Beginning of the process, the output switch S-3 of the third controller 130C is connected to an output of a power supply and the output switch is in off state. During above-described filling process, the fourth sensor 108A is also activated at the third predetermined low solution level, along with the first and second 106A, 106B of the primary sensors. This turns on the input In₂ of the third controller 130C. At this point, for example, if the third sensor 106C of the primary sensors fail and the draining is not activated, solution keeps rising towards the second predetermined high solution level of the fifth sensor 108B. Contact between the solution 105 and the fifth sensor 108B turns on the input In₁, of the third controller 130C. This closes the output switch S-3 and the output Oₚ of the switch S-3 turns on the second pump switch 132B to start draining. Similar to the embodiment performed with the primary sensors, draining first turns off the input In₁, and then just below the third predetermined solution level the input In₂ is turned off. This opens the output switch S-3 and stop draining at this level. Further, in another aspect of the present invention, if the failure of the primary sensors is remedied, the control system automatically switches back to operate between levels associated with sensors 106B and 106C as it is appreciated from the previous description.

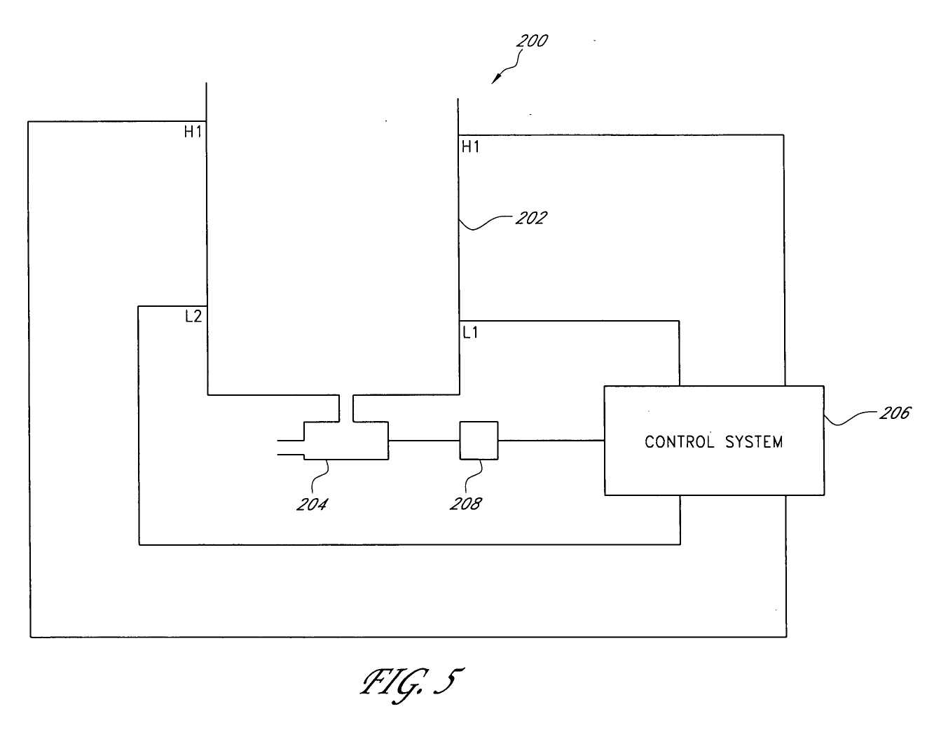

In another embodiment of the present invention, a control system using at least one sensor to detect low solution level and at least one sensor to detect high solution level will be described with help of a control logic of the control system. As shown in FIG. 5, the system 200 includes a vessel 202, a pump 204 to drain a solution from the vessel and a control system 206. The control system may be a PLC or a microcontroller. In this embodiment, the control system 206 includes four sensors a first low solution level sensor L1, a second low solution level sensor L2, a first high solution level sensor H1 and a second high solution level sensor H2. The sensors L1, L2, H1 and H2 provide signals to the controller and the controller turns on and of the pump 204 via switch 208.

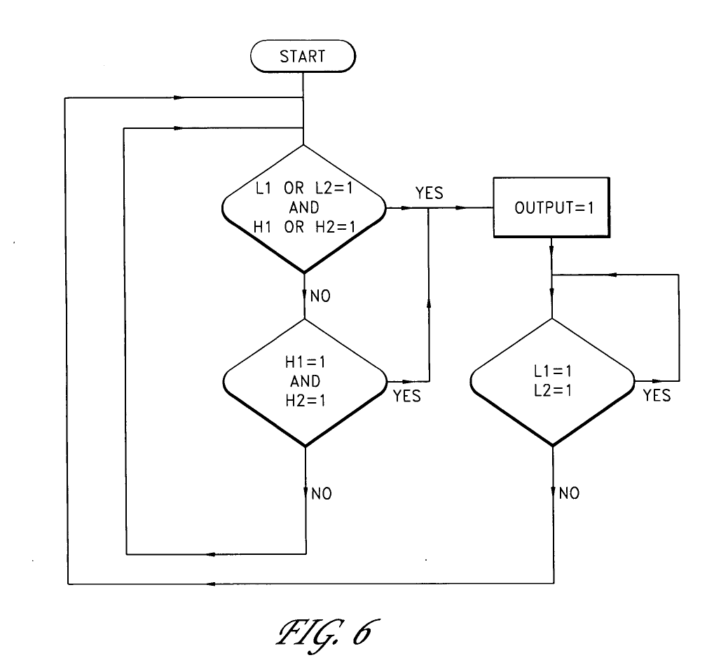

FIG. 6 illustrates an algorithm of operation schemes for the vessel 202 by using the sensors L1, L2, H1 and H2. For example, as the vessel is filled with a solution, if the sensors L1 or L2 and one of H1 or H2 is activated, i.e. generate signals for control system. The control system 206 generates an output signal and turns the switch 208 on, which turns on the drain pump and drains the solution from the vessel. Further, if the output from the control system is on and signals from the sensors L1 and L2 are still on, the output signal remains on, which keeps the pump running. However, if the output from the control system is off but the signals from the sensors L1 and L2 are on, the switch 206 remains off, thus turning off the pump. Further, if the signals from the sensors H1 and H2 are both on, even though the signals from the sensor L1 or/and L2 are off, the switch still becomes on because of a failure in sensors L1 and L2.

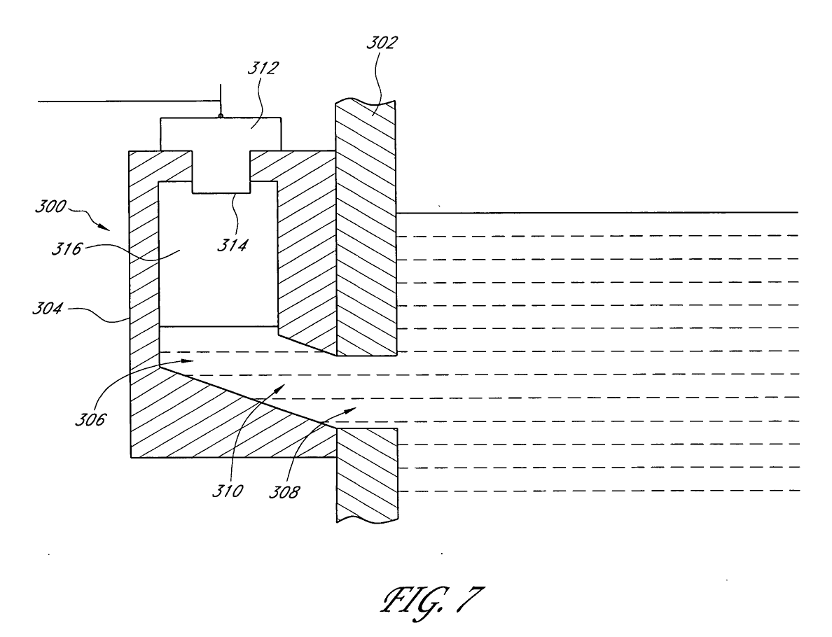

FIG. 7 illustrates an exemplary sensing device 300 of the present invention which is attached to outer surface of the side wall 302 of a vessel (not shown). The sensing device 300 includes a housing 304 having an inner cavity 306 which is connected to an opening 308 in the side wall 302 through a channel region 310 of the inner cavity. The opening 308 connects the inner cavity 306 of the sensing device 300 to the vessel, thus the fluid flows into the inner cavity through the opening 308. In this embodiment, a sensor 312 inserted into the inner cavity. The sensor 312 may be a capacitive sensor or optical sensor or other. Surface 314 of the sensor 312 is exposed in the inner cavity 306. As the fluid level is increased, an air pocket 316 forms below the sensor 312 in the inner cavity and does not allow fluid to wet the surface 314 of the sensor 312.

Although various preferred embodiments and the best mode have been described in detail above, those skilled in the art will readily appreciate that many modifications of the exemplary embodiment are possible without materially departing from the novel teachings and advantages of this invention.

We claim:

1. A method of controlling levels of a fluid in a vessel during a fluid operation including draining the fluid from the vessel or filling the fluid into the vessel, comprising:
sensing a first signal by a primary sensor set, the first signal indicating at least one first fluid level in the vessel;
sensing a second signal by a secondary sensor set, the second signal indicating the at least one second fluid level in the vessel;
controlling the fluid operation using both the first signal from the primary sensor set and the second signal from the secondary sensor set; and
controlling the fluid operation using the second signal from the secondary sensor set if the primary sensor set fails.

2. The method of claim 1, wherein the step of controlling the fluid operation using the first signal and the second signal result in draining the fluid from the vessel.

3. The method of claim 1, wherein the step of controlling the fluid operation using the second signal if the primary sensor set fails results in draining the fluid from the vessel.

4. The method of claim 1, wherein the step of controlling the fluid operation using the first signal and the second signal result in terminating the draining of the fluid from the vessel.

5. The method of claim 1, wherein the step of controlling the fluid operation using the second signal if the primary sensor set fails results in terminating the draining of the fluid from the vessel.

7. The method of claim 1 wherein the at least one first fluid level and the at least second fluid levels are about the same fluid level in the vessel.

8. The method of claim 1 wherein the at least one first fluid level and the at least one second fluid level are different fluid levels in the vessel.

9. The method of claim 1, wherein the steps of controlling the fluid operation comprise controlling a pump.

10. The method of claim 9, wherein the step of controlling the pump comprises turning on the pump to drain the vessel when the first set of signals and the second set of signals are received by the controller.

12. The method of claim 9, wherein the step of controlling the pump comprises turning on the pump to drain the vessel when the second set of signals are received by the controller.

13. The method of claim 9, wherein the step of controlling the pump comprises turning off the pump to drain the vessel when the first set of signals and the second set of signals are received by the controller.

14. The method of claim 9, wherein the step of controlling the pump comprises turning off the pump to drain the vessel when the second set of signals are received by the controller.

15. The method of claim 1 wherein the step of controlling the fluid operation using the second signal further comprises reverting back to the first signal if the primary sensor set failure is remedied.

16. A system for controlling levels of a fluid in a vessel during a fluid operation including draining a fluid from the vessel or filling the fluid into the vessel, comprising:
a primary set of sensors for receiving a first set of signals indicating at list one first fluid level;
a secondary set of sensors for receiving a second set of signals indicating at least one second fluid level; and
at least one controller for controlling the fluid operation using the first set of signals and the second set of signals, wherein the at least one controller controls the fluid operation using only the second set of signals if the primary set of sensors fails.

17. The system of claim 16 further comprising a switch connected to the at least one controller to control a drain pump.

18. The system of claim 16, wherein the primary and the secondary set of sensors are capacitive sensors.

19. The system of claim 16, wherein the primary and the secondary set of sensors are optical sensors.

20. The system of claim 16, wherein the primary and the secondary set of sensors are conductive sensors.

21. The system of claim 16, wherein the primary and the secondary set of sensors are comprised of a combination of capacitive, optical and conductive sensors.

22. The system of claim 16, wherein each sensor of the primary and the secondary set of sensors has a housing defining a cavity having a first end and a second end.

23. The system of claim 20, wherein each sensor is placed in the first end of the cavity and the fluid is received from the second end of the cavity and wherein a gas pocket separates each sensor from the fluid.

24. The system of claim 16, wherein the fluid is a conductive solution.

25. A method of preventing false reading while controlling level of a fluid in a vessel, comprising:
placing a sensor in a housing defining a cavity, the housing being placed in a predetermined fluid level in the vessel;
filling the vessel with the fluid, wherein as the fluid reaches at the predetermined fluid level the fluid enters the cavity and a gas pocket forms between the sensor and the fluid; and
sensing the predetermined level with the sensor while the gas pocket keeps the fluid away from sensor.

26. The method of claim 25, wherein the step of filling the vessel with the fluid comprises filling the vessel with an electrically conductive fluid.
